(19) United States
(12) Patent Application Publication
(10) Pub. No.: US 2008/0143528 A1
(43) Pub. Date: Jun. 19, 2008

(54) Light barrier arrangement

(75) Inventors: Paul Haberl, München (DE); Andreas Tull, Gilching (DE)

Correspondence Address: VENABLE LLP, P.O. BOX 34385, WASHINGTON, DC, 20043-9998, US

(73) Assignee: Leuze Lumiflex GmbH & Co. KG, Furstenfeldbruck (DE)

(21) Appl. No.: 12/000,736

(22) Filed: Dec. 17, 2007

(30) Foreign Application Priority Data
Dec. 16, 2006 (DE) 10 2006 059 547.5

(51) Int. Cl. G08B 13/18

(52) U.S. Cl. 340/556

(57) ABSTRACT

A light barrier arrangement for detecting objects in a monitored area includes first and second casings adapted for being arranged at opposite ends, respectively, of the monitored area. Each casing comprises a basic body having longitudinal ends. End caps close off the longitudinal ends of the basic body for the casing. Optical elements are integrated into the end caps and generate a predetermined number of beam axes formed, respectively, by emitted light rays.

### CROSS-REFERENCE TO RELATED APPLICATION

This application claims the priority of German Patent Application No. DE 10 2006 059 547.5, filed on Dec. 16, 2006, the subject matter of which is incorporated herein by reference.

### BACKGROUND

The invention relates to a light barrier arrangement for detecting objects in a monitored area, such an arrangement including two casings arranged at opposite ends of the monitored area for accommodating optical elements arranged to define a predetermined number of beam axes, respectively, along which light rays are emitted from one casing to the opposite-arranged casing.

Light barrier arrangements of this type are generally used for detecting objects within a monitored area.

Light barrier arrangements of this type generally form multi-beam light barrier systems, which function to monitor a flat area, preferably extending in one plane, for penetrating objects. For this, the light barrier arrangement is provided with optical elements that are integrated into two casings, comprising at least one transmitter for emitting light rays, at least one receiver for receiving the transmitted light rays and, if applicable, a predetermined number of reflecting mirrors. The two casings are arranged at opposite edges of the monitored area. The optical elements are positioned inside the casings so that the transmitted light rays of the light barrier arrangement are conducted within the monitored area, along several beam axes that preferably extend parallel and at a distance to each other. An object is considered detected if the transmitted light rays of at least one beam axis are interrupted.

A known variation of the foregoing light barrier arrangement is configured in the manner of a light grid, with several transmitters integrated as optical elements into a first casing for the light barrier arrangement and several receivers arranged as optical elements inside the second casing. The light rays emitted by the transmitters, which are integrated in the first casing, are then respectively conducted along a single beam axis through the monitored area and onto an associated receiver located in the second casing.

According to a further known arrangement, all active optical elements in the form of transmitters and receivers are integrated into a first casing of the light barrier arrangement while only passive optical elements in the form of reflecting mirrors are provided in the second casing. The beam conductance therefore is such that the light rays emitted by a transmitter pass for the first time through the monitored area, impinge on a first reflecting mirror in the second casing and are reflected thereon, and are then conducted to a second reflecting mirror inside the casing. The transmitted light rays are then deflected at the second reflecting mirror, such that they travel for the second time through the monitored area and are then conducted onto the receiver.

Light barrier arrangements of this type can consists of hollow profiles, in particular continuously cast metal profiles, wherein the optical elements are arranged on the inside of a hollow profile. The optical elements on the inside of the hollow profiles are positioned behind openings, which are cut into the front wall facing the monitored area of the respective hollow profile. These openings are necessary so that the light rays coming from the optical elements can be conducted into the monitored area, or so that the transmitted light rays coming from the monitored area can be conducted onto the respective optical elements.

The disadvantage of this type of arrangement is that cutting the openings into the hollow profiles represents a time-consuming and cost-intensive operation, which undesirably increases the production costs for the light barrier arrangement. Cutting the openings into the hollow profiles typically requires that the hollow profiles are clamped in and aligned, relative to the cutting tool.

It is a further disadvantage for the foregoing assemblies that the optical elements must be inserted into the hollow profiles, must be aligned inside these profiles and, finally, must be secured in the specified positions. This type of assembly is time-consuming and correspondingly expensive.

### SUMMARY

It is therefore an object of the present invention to provide a light barrier arrangement of the aforementioned type, which can be produced efficiently and cost-effectively.

The above and other objects are achieved according to the invention wherein there is provided, according to one embodiment, a light barrier arrangement for detecting objects in a monitored area, comprising: first and second casings adapted for being arranged at opposite ends, respectively, of the monitored area, each casing comprising a basic body having longitudinal ends; end caps closing off the longitudinal ends of the basic body for the casing; and optical elements integrated into the end caps and generating a predetermined number of beam axes formed, respectively, by emitted light rays.

The basic idea behind the invention therefore is to install the active optical elements in the form of transmitters and receivers, as well as the passive optical elements in the form of reflecting mirrors, inside the end caps for the basic casing bodies that preferably consist of hollow profiles.

A cost-intensive insertion of openings into the hollow profiles of the casings is thus avoided. A further streamlining effect can be achieved in that the optical elements integrated into the end caps form modules, which can be produced as pre-assembled units, thereby making it possible to dispense with the time-consuming inserting, positioning, and securing of such optical elements inside the hollow profiles of the light barrier arrangement. If a transmitter is integrated as an active optical element into an end cap, a transmitting optic and, if applicable, also the electronic components for activating the transmitter can additionally be integrated into this end cap, so that the end cap forms a complete functional unit. In the same way, an end cap can also form a functional unit comprising a receiving optic in addition to a receiver for focusing the transmitted light rays onto the receiver and, if applicable, an integrated evaluation unit with components for evaluating the received signals present at the receiver output. In general, even voltage supply components can be integrated into the end caps of these functional units, so that these for the most part form completely functional units.

A further advantage of the light barrier arrangement according to the invention is that as a result of moving the optical elements to the end caps, fitted onto the longitudinal-ends of the hollow profiles of the casings, the beam axes of the transmitted light rays that are conducted between the optical elements in the end caps can be conducted with precision in the outer edge regions of the casings.

In principle, this is not possible with traditional light barrier arrangements having the optical elements arranged exclusively inside the hollow profiles because, in order to conduct the transmitted light rays into or out of the hollow profiles with therein positioned optical elements, openings must be cut into the hollow profiles. However, such openings cannot extend to the upper edges of the hollow profiles, but must be completely surrounded by wall segments of the hollow profile.

Depending on the use of the light barrier arrangement, specific distances are required between the individual beam axes of the light barrier arrangement. For the light barrier arrangement according to the invention, the lengths for the casings can be dimensioned such that these correspond to the distance between the two outer beam axes for the light barrier arrangement. The casings therefore respectively have a minimum length that is adapted to the distance between these beam axes. This is not the case for traditional light barrier arrangements with openings cut into the hollow profiles. In that case, the lengths of the casings always exceed the distances between the beam axes since the edge segments of the hollow profiles always follow the openings in the hollow profiles, wherein caps for closing off the longitudinal-end openings in the hollow profiles must additionally be installed.

The reduced length for the casings thus results in a compact structural design for the light barrier arrangement according to the invention, wherein it is particularly advantageous that a considerable material savings can be realized as a result of the reduced length of the hollow profile.

With two-beam systems according to the invention, meaning light barrier arrangements having two beam axes, all optical elements can be integrated into the end caps. As a result, it is not necessary to cut openings into the hollow profiles forming the basic bodies of the casings.

With multi-beam systems according to the invention, meaning light barrier arrangements having three or more beam axes, the optical elements for the two beam axes along the edges are integrated into the end caps. The optical elements for the remaining beam axes are integrated into the hollow profiles of the casings, meaning that openings for these beam axes must be cut into the hollow profiles. However, a significant streamlining effect can still be achieved since only a reduced number of openings are required, as compared to traditional light barrier arrangements.

### BRIEF DESCRIPTION OF THE DRAWINGS

These and other features and advantages of the invention will be further understood from the following detailed description of the preferred embodiments with reference to the accompanying drawings showing in:

FIG. 1: A first embodiment of a light barrier arrangement according to the invention;

FIG. 2: A second embodiment of a light barrier arrangement according to the invention;

FIG. 3: A third embodiment of a light barrier arrangement according to the invention; and

FIG. 4: A fourth embodiment of a light barrier arrangement according to the invention.

### DETAILED DESCRIPTION

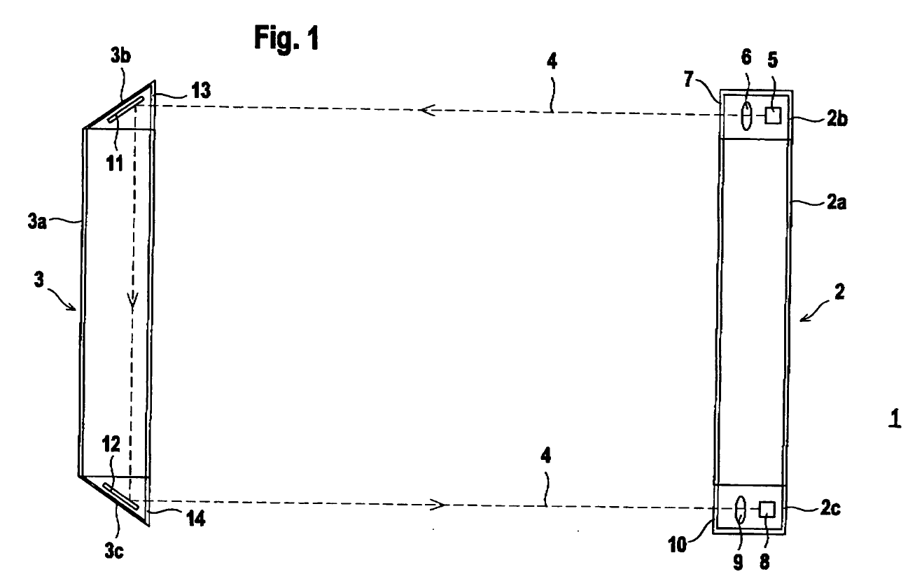

FIG. 1 illustrates a schematic representation of a first embodiment for a light barrier arrangement 1 for detecting objects in a monitored area. The light barrier arrangement 1 comprises optical elements integrated into two casings 2, 3, which are arranged opposite each other on two sides of the monitored area. The first casing 2 consists of a basic body in the form of a hollow profile 2a, as well as two end caps 2b, 2c for closing off the openings at the longitudinal ends of the hollow profile 2a. In the same way, the second casing 3 also consists of a hollow profile 3a with openings at the longitudinal ends, wherein these openings are closed off with end caps 3b, 3c.

The hollow profiles 2a, 3a for both casings 2, 3 are identical in shape and essentially have a constant rectangular or square cross section in height. The hollow profiles 2a, 3a are made of metal.

The end caps 2b, 2c, 3b, 3c are advantageously made of metal or, if applicable, of plastic and are preferably secured to the respective hollow profile 2a, 3a by a snap-in connection. In the process, the end caps 2b, 2c, 3b, 3c are inserted with the bottom sides into the openings in the hollow profiles 2a, 3a. The end caps 2b, 2c, 3b, 3c, thus tightly seal the openings in the hollow profiles 2a, 3a.

A transmitter 5 that emits light rays 4 is integrated as a first active optical element of the light barrier arrangement 1 into the end cap 2b, on the top of the first casing 2, wherein the transmitter 5 can be a light-emitting diode. A transmitting optic 6 is furthermore integrated downstream of the transmitter 5 into the end cap 2b. The transmitting optic 6 takes the form of a lens for focusing the light rays 4 into a beam. The transmitter 5 and the transmitting optic 6 are positioned inside holders, not shown herein, on the inside of the end cap 2b. The front wall, facing the monitored area, of the end cap 2b is provided with a window 7 in the form of a transparent plastic disc through which the transmitted rays 4 are conducted.

A receiver 8 for receiving the transmitted light rays 4 is integrated into the end cap 2c on the bottom of the first casing 2 as second active optical element of the light barrier arrangement 1. The receiver 8 includes of a photoelectric diode or the like. A receiving optic 9 in the form of a lens is provided upstream of receiver 8 for focusing the transmitted light rays 4 onto the receiver. Corresponding to the first end cap 2b, a window 10 in the form of a plastic disc is also provided in the front wall of the second end cap 2c.

The cross sections for the identically designed end caps 2b, 2c of the first casing 2 essentially correspond to the cross section of the hollow profile 2a.

The electronic components (not shown) for activating the transmitter 5 and for evaluating the received signals present at the output of the receiver 8 are integrated into the hollow profile 2a of the first casing 2. The transmitter 5 and the receiver 8 are connected to a control unit (not shown), similarly integrated into the hollow profile 2a, wherein the respective feed lines (not shown) extend from the control unit to the transmitter 5 and the receiver 8 in the end caps 2b, 2c. Alternatively, an electronic component for activating the transmitter 5 can be integrated into the end cap 2b and an electronic component for evaluating the signals received at the receiver 8 can be integrated into the end cap 2c.

The end caps 3b, 3c of the second casing 3 respectively contain one reflecting mirror 11, 12 as a passive optical element, designed to reflect the transmitted light rays 4. The planes for the reflecting mirrors 11, 12 extend at a 45° angle, relative to the longitudinal axis of the casing 3 that extends in a vertical direction. The reflecting mirrors 11, 12 are secured in position on the inside of the end caps 3b, 3c, with the aid of holders that are not shown herein. The contours of the end caps 3b, 3c for the second casing 3 are identical in design and are adapted to the installation position of the reflecting mirrors 11, 12. Windows 13, 14 in the form of transparent plastic discs are again integrated into the front walls of the end caps 3b, 3c.

As shown in FIG. 1, the light rays 4 emitted by the transmitter 5 are conducted through the window 7 into the monitored area. These rays pass for the first time through the monitored area and then impinge on the reflecting mirror 11 in the end cap 3b for the second casing 3. The transmitted light rays 4 are reflected at this mirror by 90°, so that they travel inside the hollow profile 3a to the reflecting mirror 12 in the end cap 3c. The transmitted light rays 4 are again reflected by 90° and then travel through the monitored area a second time, but in the opposite direction, and are then conducted to the receiver 8. The transmitted light rays 4, which are conducted in opposite directions through the monitored area, form two spaced apart, parallel beam axes for the light barrier arrangement 1. The light barrier arrangement 1, configured in this way, consequently forms a so-called two-beam system.

If the monitored area is clear, then the light rays 4 emitted by the transmitter 5 can travel uninterrupted via the reflecting mirrors 11, 12 back to the receiver 8. Accordingly, an object detection signal with the switching state “monitored area clear” is generated in the control unit in dependence on the received signals, preferably with the aid of a threshold evaluation of the received signals.

At least one beam axis is interrupted if an object penetrates the monitored area. In that case, an object report, meaning an object detection signal with the switching state “object detected,” is generated in the control unit. The binary object detection signal is transmitted via a switching output that is not shown herein.

The light barrier arrangement 1 can be used in particular in the area of safety technology. For this, the control unit preferably has a redundant two-channel design for securely generating an object detection signal. A light barrier arrangement 1 of this type can be used to monitor the danger zone surrounding a machine or the like.

The light barrier arrangement 1 advantageously controls the machine operation so that an operation is authorized only if the monitored area is clear and so that the machine is shut down if an object intervenes in the monitored area. For this, the object detection signal is read out to the machine control.

A corresponding evaluation is made for the following, additional exemplary embodiments.

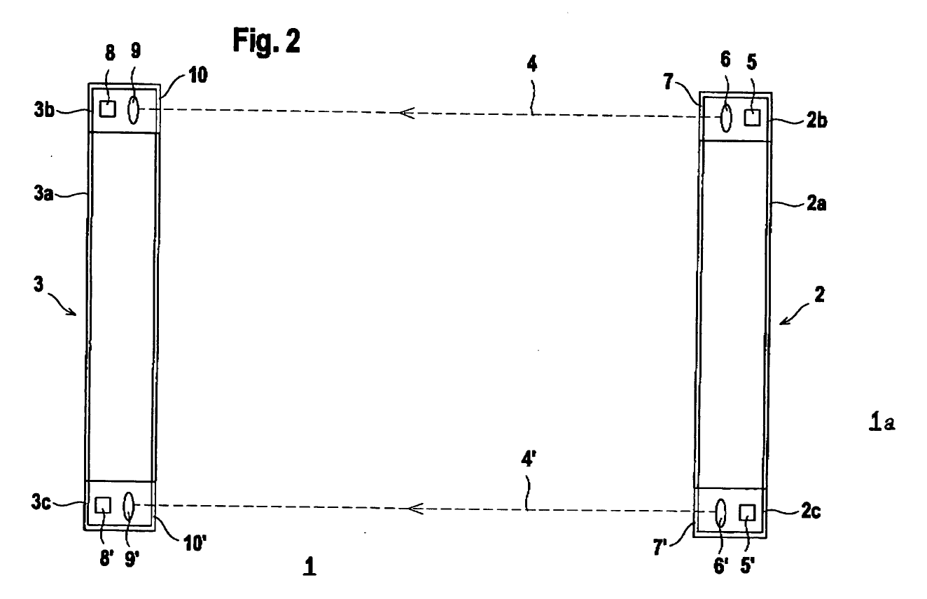

FIG. 2 shows a second embodiment of a light barrier arrangement 1a. This light barrier arrangement 1a is embodied as a two-beam system, analogous to the embodiment shown in FIG. 1, wherein all optical elements are integrated into the end caps 2b, 2c, 3b, 3c of the two casings 2, 3, further coinciding with the embodiment shown in FIG. 1.

In contrast to the embodiment shown in FIG. 1, the embodiment according to FIG. 2 has only active optical elements for forming a beam integrated into the end caps 2b, 2c, 3b, 3c of the two casings 2, 3. Respectively one transmitter 5, 5′ and one transmitting optic 6, 6′ are integrated into the end caps 2b, 2c of the first casing 2. The light rays 4, 4′ emitted by the transmitters 5, 5′ are each conducted through a window 7, 7′ in the front wall of the respective end caps 2b, 2c and into the monitored area. The transmitters 5, 5′ are activated by a joint electronic control (not shown) that is integrated into the hollow profile 2a.

The end caps 3b, 3c of the second casing 3 respectively contain one receiver 8, 8′ and one receiving optic 9, 9′, which are arranged behind the windows 10, 10′ in the front walls for the end caps 3b, 3c. The received signals are evaluated in an evaluation unit (not shown), which is arranged inside the hollow profile 3a of the second casing 3.

The light rays 4 emitted by the transmitter 5 in the upper end cap 2b of the first casing 2 travel through the monitored area and impinge on the receiver 8, positioned in the upper end cap 3b of the second casing 3. These light rays 4 jointly form the first beam axis for the light barrier arrangement 1. The light rays 4′ emitted by the transmitter 5′ in the lower end cap 2c of the first casing 2 travel through the monitored area and then impinge on the receiver 8′ in the lower end cap 3c of the second casing 3, wherein these light rays 4′ jointly form the second beam axis of the light barrier arrangement 1. An object report is generated if at least one beam axis is interrupted by an intervening object.

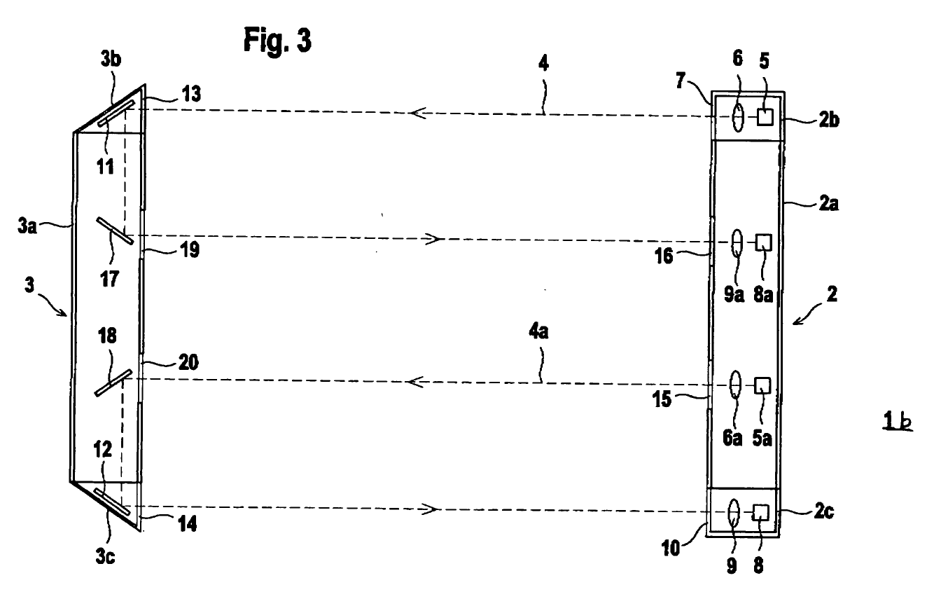

FIG. 3 shows a four-beam system, which is a modified version of the embodiment shown in FIG. 1. The light barrier arrangement 1b according to FIG. 3 is identical to the embodiment according to FIG. 1, with respect to the design of the end caps 2b, 2c, 3b, 3c and the optical elements arranged therein.

In a further modification of the embodiment shown in FIG. 1, the light barrier arrangement 1b according to FIG. 3 is provided with additional optical elements that are integrated into the hollow profiles 2a, 3a for the two casings 2, 3.

A second receiver 8a with upstream positioned receiving optic 9a and a second transmitter 5a with downstream positioned transmitting optic 6a are provided in the hollow profile 2a for the first casing 2. The second transmitter 5a is assigned to the first receiver 8. The second transmitter 5a is positioned behind a window 15, which is integrated into an opening in the front wall of the hollow profile 2a. The second receiver 8a is positioned behind another window 16, which is also integrated into an opening in the front wall of the hollow profile 2a.

The hollow profile 3a for the second casing 3 contains two additional reflecting mirrors 17, 18 as further optical elements, for which the mirror planes are inclined by an angle of 45°, relative to the longitudinal axis for the casing 3.

The individual reflecting mirrors 17, 18 are positioned behind separate windows 19, 20 arranged in openings in the front wall of the hollow profile 3a.

With an uninterrupted beam path, the light rays 4 emitted by the transmitter 5 travel through the monitored area, then impinge on the reflecting mirror 11 where they are reflected, such that they are conducted to the reflecting mirror 17 while traveling inside the hollow profile 3a. The transmitted light rays 4 are reflected at the reflecting mirror 17 and then travel in the opposite direction, once more through the monitored area, and are conducted onto the second receiver 8a. The transmitted light rays 4 consequently form the first two beam axes of the light barrier arrangement 1b.

The light rays 4a emitted by the second transmitter 5a correspondingly travel in the same way through the monitored area, impinge on the reflecting mirror 18 and are reflected thereon, such that they are conducted inside the hollow profile 3a to the reflecting mirror 12. At this reflecting mirror 12, the transmitted light rays 4a are reflected once more and then travel in the opposite direction, again through the monitored area, and are then conducted onto the first receiver 8. The transmitted light rays 4a thus form two further beam axes of the light barrier arrangement 1b.

An object detection report is issued if an object interrupts at least one beam axis for the light barrier arrangement 1b.

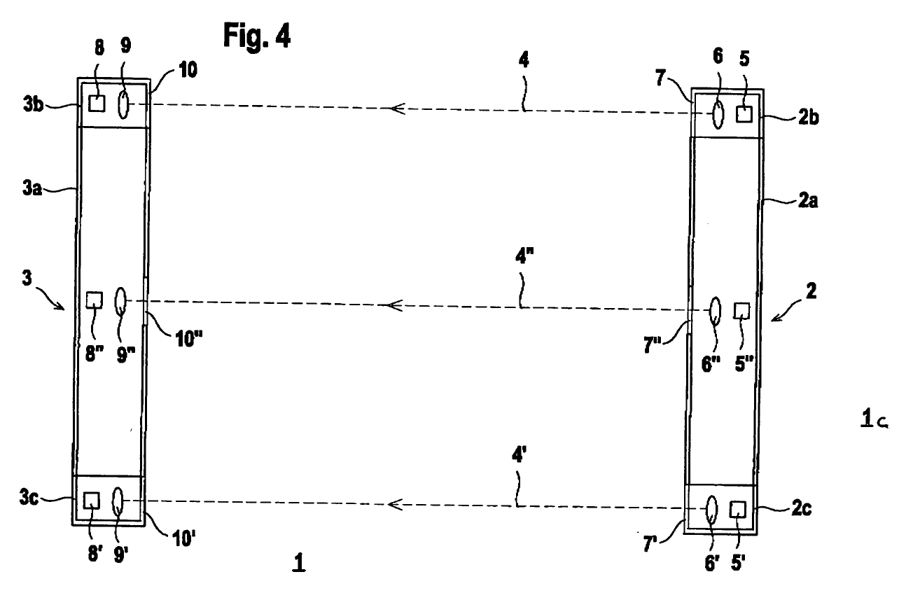

FIG. 4 illustrates an expansion of the embodiment according to FIG. 2, to form a three-beam system. The light barrier arrangement 1c according to FIG. 4 is identical to the embodiment shown in FIG. 2 with respect to the design of the end caps 2b, 2c, 3b, 3c and the optical elements arranged therein.

The embodiment shown in FIG. 4 is a modified version of the embodiment shown in FIG. 2, containing additional optical elements integrated into the hollow profiles 2a, 3a of the two casings 2, 3 for the light barrier arrangement 1c.

A third transmitter 5 ″ with a transmitting optic 6″ in front is integrated into the hollow profile 2a of the first casing 2. The transmitter 5″ is positioned behind a window 7″ in an opening in the front wall of the hollow profile 2a.

A third receiver 8″ with upstream receiving optic 9″ is integrated into the hollow profile 3a of the second casing 3. This receiver 8″ is positioned behind a window 10″ in an opening in the front wall for the hollow profile 3b.

The light rays 4″ emitted by the transmitter 5″ and conducted to the receiver 8″ form the third beam axis of the light barrier arrangement 1, in addition to the beam axes formed with the light rays 4, 4′ emitted by the transmitters 5, 5′ in the end caps 2b, 2c.

It will be understood that the above description of the present invention is susceptible to various modifications, changes and adaptations, and that the same are intended to be comprehended within the meaning and range of equivalents of the appended claims.

What is claimed is:

1. A light barrier arrangement for detecting objects in a monitored area, comprising:
first and second casings adapted for being arranged at opposite ends, respectively, of the monitored area, each casing comprising a basic body having longitudinal ends;
end caps closing off the longitudinal ends of the basic body for the casing; and
optical elements integrated into the end caps and generating a predetermined number of beam axes formed, respectively, by emitted light rays.

2. The light barrier arrangement according to claim 1, wherein at least one optical element is a transmitter for emitting light rays.

3. The light barrier arrangement according to claim 2, wherein the optical elements include a transmitting optic positioned in front of the transmitter and the transmitter together with the transmitting optic are integrated into one of the end caps.

4. The light barrier arrangement according to claim 2, and further including an electronic component for activating the transmitter integrated into the end cap which accommodates the transmitter.

5. The light barrier arrangement according to claim 2, wherein at least one optical element is a receiver arranged to receive the transmitted light rays.

6. The light barrier arrangement according to claim 5, wherein the optical elements include a receiving optic positioned in front of the receiver and the receiver together with the receiving optic are integrated into one of the end caps.

7. The light barrier arrangement according to claim 5, and further including an evaluation electronic integrated into the end cap that accommodates the receiver.

8. The light barrier arrangement according to claim 1, wherein the optical elements include a reflecting mirror.

9. The light barrier arrangement according to claim 1, wherein all optical elements are integrated into the end caps of the casings.

10. The light barrier arrangement according to claim 1, and further including other optical elements arranged in the basic bodies for the casings in addition to the optical elements integrated in the end caps.

11. The light barrier arrangement according to claim 10, wherein the basic bodies include openings behind which the other optical elements are positioned and through which light rays are conducted.

12. The light barrier arrangement according to claim 1, wherein each basic body comprises a hollow profile.

13. The light barrier arrangement according to claim 12, wherein the hollow profiles comprise metal.

14. The light barrier arrangement according to claim 1, wherein the end caps comprise at least one of metal or plastic.

15. The light barrier arrangement according to claim 1, wherein the optical elements include transmitters arranged in the first casing and receivers arranged in the second casing, and the transmitters emit respective light rays that are conducted to an associated receiver.

16. The light barrier arrangement according to claim 1, wherein the optical elements include at least one transmitter and one receiver arranged in separate end caps of the first casing and at least two reflecting mirrors arranged in separate end caps in the second casing, the transmitter emitting light rays that travel for the first time through the monitored area along a first beam axis, impinge on a first one of the reflecting mirrors and is reflected thereon, and is subsequently conducted inside the casing to a second one of the reflecting mirrors, is reflected once more, and then travels for the second time along a second beam axis through the monitored area and onto the receiver.

17. The light barrier arrangement according to claim 10, wherein:
the optical elements include: a first transmitter integrated into a first end cap of the first casing, a first receiver integrated into a second end cap of the first casing, a first reflecting mirror integrated into a first end cap of the second casing and aligned with the first transmitter to form a first beam axis, and a second reflecting mirror integrated into a second end cap of the second casing and aligned with the first receiver to form a second beam axis; and
the other optical elements include: a second receiver arranged in the first casing and a third reflecting mirror arranged in the second casing and forming a third beam axis with the second receiver, whereby the first transmitter emits a first beam that travels for the first time through the monitored area along the first beam axis, is reflected by the first reflecting mirror toward the third reflecting mirror where the first beam is reflected along the third beam axis and travels for a second time through the monitored area toward the second receiver; the other optical elements further including a second transmitter arranged in the first casing and a fourth reflecting mirror arranged in the second casing and forming a fourth beam axis with the second transmitter, whereby the second transmitter emits a second beam that travels for a first time through the monitored area along the fourth beam axis, is reflected by the forth reflecting mirror toward the second reflecting mirror where the second beam is reflected along the second beam axis and travels for a second time through the monitored area toward the first receiver.
